(19) United States
(12) Patent Application Publication
(10) Pub. No.: US 2025/0264389 A1
(43) Pub. Date: Aug. 21, 2025

(54) IMPLANT ABRASION AND ATTACHMENT STRENGTH TESTING

(71) Applicant: Oregon State University, Corvallis, OR (US)

(72) Inventors: Ravi Balasubramanian, Corvallis, OR (US); Justin C. Casebier, Portland, OR (US)

(73) Assignee: Oregon State University, Corvallis, OR (US)

(21) Appl. No.: 19/054,112

(22) Filed: Feb. 14, 2025

Related U.S. Application Data
(60) Provisional application No. 63/554,057, filed on Feb. 15, 2024.

(51) Int. Cl. G01N 3/14; G01N 3/56

(52) U.S. Cl. CPC G01N 3/14; G01N 3/56

(57) ABSTRACT

Examples are described for testing an implant for abrasion and attachment strength under a simulated environment. An example apparatus for testing an implant coupled to a simulated musculoskeletal component includes a base layer of simulated tissue positioned under a bottom surface of the implant and a top layer of simulated tissue positioned over a top surface of the implant. A linear actuator may be configured to generate and apply translational force to a proximal end of the simulated musculoskeletal component to simulate translational movement of the implant against the simulated tissue. A tensioner may be configured to apply differential force to distal ends of the simulated musculoskeletal component to simulate rotational movement of the implant against the simulated tissue responsive to the translational force applied to the proximal end of the simulated musculoskeletal component.

### CROSS REFERENCE TO RELATED APPLICATION

This application claims the benefit of U.S. Provisional Application No. 63/554,057, entitled “Implant Abrasion and Attachment Strength Testing” and filed Feb. 15, 2024, which is herein incorporated by reference in its entirety.

### ACKNOWLEDGMENT OF GOVERNMENT SUPPORT

This invention was made with government support under Grant No. 2016530 awarded by the National Science Foundation. The government has certain rights in the invention.

### FIELD

This disclosure relates generally to mechanisms for testing implants and methods for using such mechanisms to perform abrasion and attachment strength tests on implants.

### BACKGROUND

Tendon-transfer surgeries are performed to partially restore musculoskeletal function for a variety of conditions such as stroke, paralysis, nerve, muscle, brain, or spinal trauma, and congenital disorders. Surgical techniques for restoring or improving musculoskeletal function typically involve attaching the muscles and tendons to a bone or muscle using sutures. In at least fifteen types of hand tendon-transfer surgeries, a single donor muscle is directly sutured to multiple recipient tendons. The suture couples the movement of the muscle and the tendons to replicate prior function, but cannot preferentially enhance, scale, or distribute a muscle's force and movement across the tendons. This leads to limited post-surgery musculoskeletal function and surgical choices.

Prior work has explored three primary types of medical devices for restoring or enhancing musculoskeletal function: (1) rigid passive implants that directly attach to bones, such as joint replacement implants or implants for holding bones together after fractures; (2) implants that secure two biological tendons, such as tenofix and Otho-Hunter implants, or biological tendons to bone, such as the Orthocoupler implant; and (3) external devices that are body-powered or externally powered, such as prostheses for lost body parts, orthoses for correcting misalignments, or exoskeletons for assisting in movement.

A common type of surgery for the improvement of musculoskeletal function includes tendon-transfer surgery. Tendon-transfer surgery restores lost hand function by re-routing one or more tendons from the affected muscle and suturing them to a functioning muscle. In order to provide enhanced hand movement control and strength, an implant may be connected between a muscle and a joint along a tendon and/or otherwise attached to tendons in the hand. Implants may also be used in other environments for improved musculoskeletal function. However, the implant may be subject to various forces within the body, such as the stretching and rotation of muscles, tendon, and other tissue around the implant, which may abrade the implant and put strain on attachment points of the implant to the muscle, tendon, and/or bone, which may lead to issues such as decreased effectiveness or dislodgement of the implant over time.

Accordingly, there is a need in the art to develop mechanisms and methods for their use for testing abrasion resiliency and attachment strength of implants.

### SUMMARY

Certain disclosed examples concern the testing of an implantable passive engineered mechanism. The mechanism may comprise biocompatible materials and/or at least a portion thereof may be coated with a biocompatible material. A testing apparatus may be used to simulate body movements and the interaction of simulated tendons and other bodily tissue with the mechanism during such movements in order to determine effects of the movement on the implant. Relative to other testing approaches, the disclosed technologies advantageously generate more realistic movements analogous to real-world environments of an implant by allowing for control over translational/linear movement, rotational movement, and pressure of surrounding tissue on an implant under test.

In one example, an apparatus for testing an implant in a simulated environment includes a linear actuator and a tensioner comprising a first spring and a second spring. A simulated proximal tendon may be coupled to the linear actuator, wherein the linear actuator is configured to apply a translational force on the simulated proximal tendon. Simulated distal tendons may be respectively coupled to the first spring and the second spring, wherein the implant is coupled between the simulated proximal tendon and the simulated distal tendons. An enclosure comprising a first, base layer of simulated tissue and a second, top layer of simulated tissue may be included in the apparatus, wherein the implant is positioned between the first, base layer and the second, top layer. One or more sensors may be configured to measure the amount of force applied to the implant by the apparatus.

In another example, an apparatus for testing an implant coupled to a simulated musculoskeletal component includes a base layer of simulated tissue positioned under a bottom surface of the implant and a top layer of simulated tissue positioned over a top surface of the implant. A linear actuator may be configured to generate and apply translational force to a proximal end of the simulated musculoskeletal component to simulate translational movement of the implant against the simulated tissue. A tensioner may be configured to apply differential force to the distal ends of the simulated musculoskeletal component to simulate rotational movement of the implant against the simulated tissue responsive to the translational force applied to the proximal end of the simulated musculoskeletal component.

In other examples, a method of testing an implant includes attaching an implant between a simulated proximal tendon and simulated distal tendons using one or more attachment mechanisms, and inserting the implant in an enclosure including a top layer of simulated tissue and a base layer of simulated tissue, wherein the implant is positioned between the top layer of simulated tissue and the base layer of simulated tissue. The method may further include attaching a first end of the simulated proximal tendon to a linear actuator, and attaching a second end of the simulated distal tendons to a tensioner or springs. The linear actuator may be operated to apply a translational force to the simulated proximal tendon and to subject the implant to translational and rotational forces from the linear actuator and the tensioner. An amount of abrasion of a coating of the implant or a strength of the attachment mechanisms may be measured.

The foregoing and other objects, features, and advantages of the disclosed technologies will become more apparent from the following detailed description, which proceeds with reference to the accompanying figures.

### BRIEF DESCRIPTION OF THE DRAWINGS

FIGS. 1-2C show example implants that may be tested using an implant testing system in accordance with embodiments of the present disclosure.

FIG. 3 is a top perspective view showing an example of an implant testing system in accordance with embodiments of the present disclosure.

FIG. 4 is a top view showing another example of the implant testing system.

FIG. 5 is a side view showing an example of the implant testing system.

FIG. 6 is a top perspective view showing details of a linear actuator of the implant testing system.

FIG. 7 is a schematic diagram showing example circuitry for the linear actuator of the implant testing system.

FIGS. 8A and 8B show different views of an example enclosure for an implant under test of the implant testing system.

FIGS. 9A-10 show examples of enclosure components for an implant under test of an implant testing system for use in accordance with embodiments of the present disclosure.

FIGS. 11A and 11B show different views of a solution bath in which an implant is submerged for testing using an implant testing system for use in accordance with embodiments of the present disclosure.

FIGS. 12A and 12B show different views of a pulley system of an implant testing system for use in accordance with embodiments of the present disclosure.

FIGS. 13A and 13B show examples of pressure sensors of an implant testing system for use in accordance with embodiments of the present disclosure.

FIG. 14 shows an example circuit diagram for a pressure sensor of an implant testing system for use in accordance with embodiments of the present disclosure.

FIG. 15 shows an example of load sensors for springs of an implant testing system for use in accordance with embodiments of the present disclosure.

FIG. 16 shows a schematic side view of another example of an implant testing system for use in accordance with embodiments of the present disclosure.

FIG. 17 shows a schematic perspective view of another example of an implant testing system for use in accordance with embodiments of the present disclosure.

FIG. 18 is a flow chart of an example method of testing an implant using an implant testing system in accordance with embodiments of the present disclosure.

FIG. 19 depicts a generalized example of a suitable computing environment in which the described innovations may be implemented.

### DETAILED DESCRIPTION

### I. Introduction

Passive engineered mechanisms may be implanted at any of various locations in a subject. For example, implants may be used for tendon-transfer surgery and/or in general orthopedic surgery, to improve the functional attachment of muscles to tendons and bones. Common locations for implantation include, but are not limited to: (1) the hand, wherein the four tendons of the fingers (the flexor digitorum profundus, FDP, tendons) are coupled to the extensor carpi radialis longus (ECRL), the muscle of the forearm; (2) the elbow, wherein the biceps brachii is coupled to the ulna or the radius; and (3) the knee, wherein tendons are used to couple the large muscles of the thigh, such as the vastus medialis, vastus intermedius, and vastus lateralis, to the patella.

### II. Definitions

The following explanations of terms and abbreviations are provided to better describe the present disclosure and to guide those of ordinary skill in the art and practice of the present disclosure.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the detailed description and the claims.

As used herein, “comprising” means “including” and the singular forms “a” or “an” or “the” include plural references unless the context clearly dictates otherwise.

The term “or” refers to a single element of stated alternative elements or a combination of two or more elements, unless the context clearly indicates otherwise.

In order to facilitate review of the various embodiments of the disclosure, the following explanations of specific terms are provided:

Biocompatible: A substantially non-toxic material in vivo that is not substantially rejected by the patient's physiological system (e.g., is nonantigenic). This can be gauged by the ability of a material to pass the biocompatibility tests set forth in International Standards Organization (ISO) Standard No. 10993 and/or the U.S. Pharmacopcia (USP) 23 and/or the U.S. Food and Drug Administration (FDA) blue book memorandum No. G95-1, entitled “Use of International Standard ISO-10993, Biological Evaluation of Medical Devices Part-1: Evaluation and Testing.” Typically, these tests measure a material's toxicity, infectivity, pyrogenicity, irritation potential, reactivity, hemolytic activity, carcinogenicity and/or immunogenicity. A biocompatible structure or material, when introduced into a majority of subjects, will not cause a significantly adverse reaction or response. Furthermore, biocompatibility can be affected by other contaminants such as prions, surfactants, oligonucleotides, and other agents or contaminants. The term “biocompatible material” refers to a material that does not cause toxic or injurious effects on a tissue, organ, or graft. Examples, without limitation, of biocompatible materials include: titanium, ultra-high molecular weight polyethylene, polyvinylidene fluoride, and elastomers.

Coat: As used herein, “coat,” “coating,” “coatings,” and “coated” are forms of the same term referring to materials and process for making a material where a first substance or substrate surface is at least partially covered or associated with a second substance. The first and second substances may be, but are not required to be, different. Further, when a surface is “coated” as used herein, the coating may be effectuated by any chemical or mechanical bond or force, including linking agents. The “coating” need not be complete or cover the entire surface of the first substance to be “coated.” The “coating” may be complete as well (e.g., approximately covering the entire first surface). There can be multiple coatings and multiple substances within each coating. The coating may vary in thickness or the coating thickness may be substantially uniform. Coatings contemplated in accordance with the present disclosure include, but are not limited to, biocompatible coatings, medicated coatings, drug-eluting coatings, drugs or other compounds, pharmaceutically acceptable carriers and combinations thereof, or any other organic, inorganic or organic/inorganic hybrid materials. Examples of biocompatible coatings include, but are not limited to: polyurethane, phosphorylcholine, bovine submaxillary mucin coatings, covalently grafted non-fouling layers, or surface immobilized brushes of chemicals including but not limited to sulfobetaine.

Subject: An animal or human subjected to a treatment, observation or experiment.

### III. Descriptions of Implantable Mechanisms

Disclosed herein are various examples of testing systems that may be used to test any suitable implantable device. While the disclosure is not limited to testing a specific type of implant, examples of implantable passive-engineered mechanisms are provided for illustrative purposes to show how the testing systems may be used. Disclosed example implants are useful to, for example, improve the functional attachment of muscles to tendons and bones by modifying the transmission of forces and movement inside the body.

Certain disclosed embodiments are force scaling implants that are used to connect a single input force to a single output force and to allow for the input force to be scaled up or down to create a stronger or weaker output force. The input force may be an active muscular or tendon force, or a passive input, for example tenodesis. In tenodesis the tendon can be anchored to a bone or other fixed structure such that the rotation of the joint distal to the anchor lengthens the path of the mechanism, producing a force.

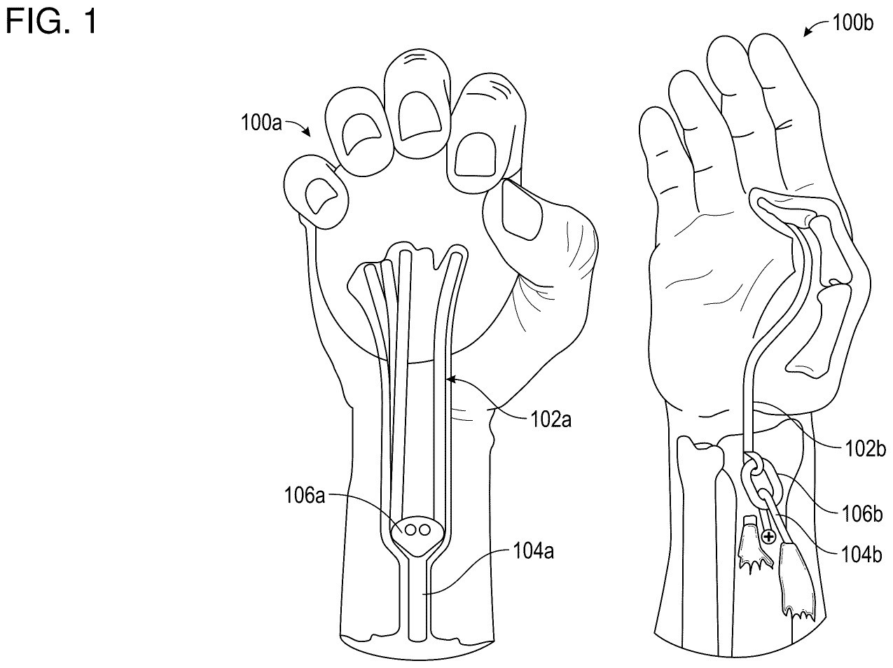

FIG. 1 illustrates exemplary implantable mechanisms. In a first example of a hand 100a, a first example implant 106a may be attached between a proximal tendon 104a and distal tendons 102a. In a second example of a hand 100b, a second example implant 106b may be attached between a proximal tendon 104b and a distal tendon 102b. The proximal tendon 104b may be attached to the implant 106b and anchored to bone in some examples.

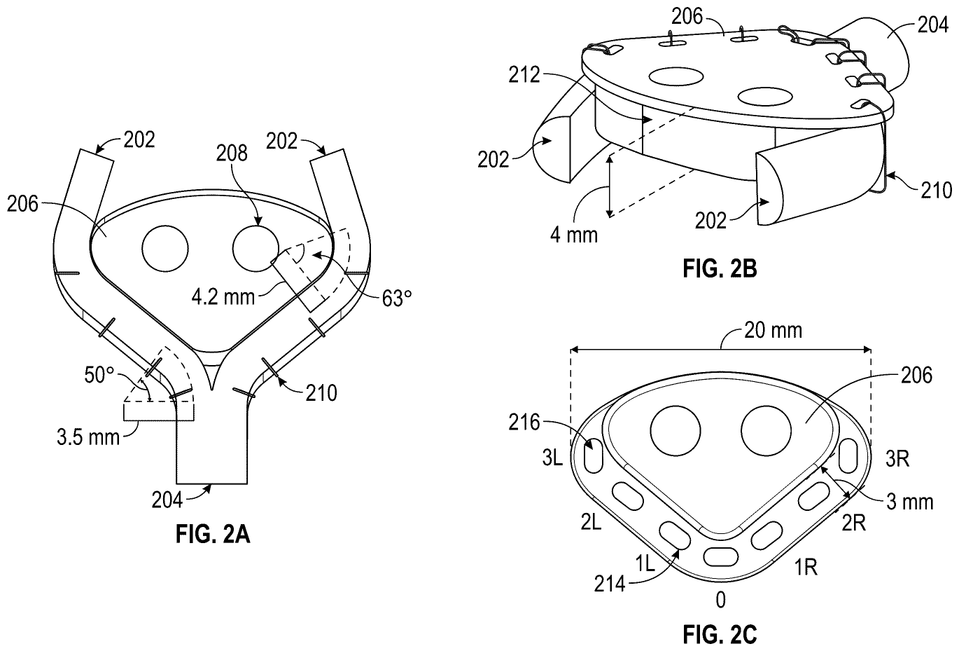

FIGS. 2A-2C show detailed schematic views of an example implant 206 that is similar to implant 106a of FIG. 1. In a schematic bottom view shown in FIG. 2A, the implant 206 is shown as a triangular-shaped material positioned between a proximal tendon 204 and distal tendons 202. A body of the implant 206 includes k-wire holes 208 that extend from a top surface through toward a bottom surface of the implant. The implant 206 may be attached to the tendons 202 and 204 via any suitable attachment mechanism, including sutures 210 shown in FIG. 2A and FIG. 2B. In a schematic side perspective view shown in FIG. 2B and a schematic bottom view shown in FIG. 2C, additional features of the shape of the implant are visible, including a side wall opening 212 and suture channels 214, which are formed to at least partially enclose or cover the tendons when implanted. The suture channels 214 may include a plurality of suture holes 216 through which sutures are passed to secure the tendons to the implant as shown best in FIG. 2B. Other methods of attachment, such as screws, between the implant and the tendon may also be used.

It is to be understood that the disclosed example implants are not exhaustive, and are provided for illustrative purposes only. Other implants having different sizes, shapes, methods of attachment between the implant and the tendon, and/or functionality than the examples shown and described above may be tested using the example testing systems described herein. For example, an implant may include a pulley or system of pulleys (e.g., a triangular arrangement of pulleys) configured to be connected to tendon and/or muscle. Implants that can be tested using the example testing systems described herein are also not limited to those configured to be implanted in the hand/wrist, and may be configured to be implanted in any suitable location of a subject's body.

### IV. Implantable Materials

A. Materials

In considering materials for implantable mechanisms biocompatibility, tensile strength, ability to remain inert, and resistance to fibrosis are useful characteristics to consider. Materials should not trigger inflammation or immune responses. Materials may be chosen based on one or all of the above considerations depending on what function they are serving.

Polymers are large molecules comprised of smaller related subunits. Polymer architecture, chain length, and arrangement affect the properties of the polymer. Longer chain lengths increase impact resistance and strength. Tensile strength of polymers increases as polymer chain length and crosslinking increase. With respect to polymers, suitable candidates include polyalkylenes, such as polyethylene, particularly Ultra High Molecular Weight Polyethylene (UHMWPE), nylon, polyester/polyethylene terephthalate (PET) and elastomers. Particular examples include poly-paraphenylene terephthalate and combinations thereof.

In some embodiments, the materials implanted in the body will be metals and alloys. Metals and metal alloys may be chosen based on some, all, or none of the above considerations. Likely candidates for metals and metal alloys include titanium, stainless steel (e.g., for temporary implants, least corrosion resistant), tantalum, and combinations thereof.
B. Coatings/Sheaths

In some embodiments, the implantable materials must be coated partially or substantially completely to facilitate biocompatibility. Materials may be selected to inhibit or reduce fibrosis and tissue ingrowth and to inhibit biological adsorption and interaction events. Examples include but are not limited to polyurethane, phosphorylcholine, zwitterionic coatings (e.g., zwitterionic compounds including polypeptides, betains, and/or phosphorylcholine polymers with hydrophilic properties), bovine submaxillary mucin coatings, covalently grafted non-fouling layers, surface immobilized brushes of chemicals including, but not limited to, sulfobetaine, and combinations thereof. In some embodiments component surfaces may be modified with a covalently-grafted, non-fouling layer or with a surface-immobilized brush (short polymeric chains densely grafted to a surface) of chemicals including but not limited to sulfobetaine (SB).

Accordingly, an exemplary list of suitable materials includes, but is not limited to, Ceramic materials, such as magnesium aluminate spinel (inert biocompatible ceramic); polymers, such as PEEK (polyetheretherketone), PEKK (poly (oxy-p-phenylencisophthaloyl-phylene/oxy-p-phenyleneterephthaloyl-p-phenylene), carbon-reinforced polymer composites, polyester, PET, silicone, PTFE (polytetrafluoroethylene) or ePTFE (expanded PTFE), PUR (polyurethane), PFA (perfluoroalkoxy alkane), FEP (Fluorinated ethylene propylene), UHMWPE, polyesters, polyanhydrides, polyethylenes, polyorthoesters, polyphosphazenes, polyurethane, polycarbonate urethane, silicones, polyolefins, polyamides, polycaprolactams, polyimides, polyvinyl alcohols, acrylic polymers and copolymers, polyethers, cellulosics and any of their combinations in blends or as copolymers; silicone backbone-modified polycarbonate urethane; metals, such as titanium and tantalum; alloys, such as nickel titanium, cobalt chrome alloys, stainless steel, shape memory alloys, nickel cobalt, titanium niobium; minerals, such as tricalcium phosphate (TCP) (controls tissue response), pyrolitic carbon; and coatings, such as hydroxyapatite (HA) and PEG (polyethylene glycol).

In some embodiments, the implantable materials may be fully enclosed in a biocompatible sheath to prevent interference with the surrounding biological tissues.

### V. Implant Testing System

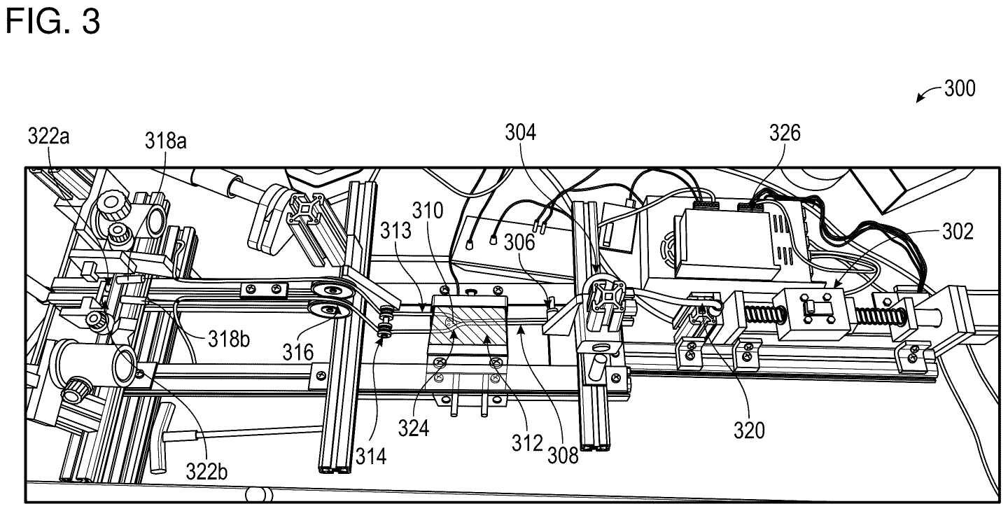

FIG. 3 shows an example implant testing system 300 configured to simulate the environment of an implant and to subject the implant to movements corresponding to those experienced by the implant when implanted in a subject's body. As described above, depending on the location of the implantation, implants may experience different types of movement, which may strain points of connection (e.g., sutures or other attachment points) between the implant and the muscles or tendons. Additionally, implants may be coated with a material that reduces implant rejection and fibrosis and/or that reduces friction in order to enhance the performance of the implant. The interaction of surrounding tissue, muscles/tendons, and/or other surrounding material contacting the implant during the above-described movements abate the coating over time. Accordingly, by simulating these movements and environments, the implant testing system 300 may be used to identify abrasion and strength considerations for the implant, such as an amount and/or location/distribution of abrasion experienced by the implant during use and a strength of sutures or other attachment mechanisms used to connect the implant to other components in the subject's body.

Such testing may be helpful to estimate a lifespan of implants, their coatings, and/or to test different configurations/materials in order to identify better performing implant designs. For example, the abrasion testing may be used to determine how long it takes for the coating to wear, and locations that experience the most wear, which may be used to determine ways to improve the implant by adjusting a distribution of the coating to reinforce areas that experience more abrasion, while the strength testing may be used to determine how long it takes for one or threshold number of the sutures to fail/break, which sutures break or fray fastest, etc., which may be used to determine ways to improve the implant by adjusting a placement, number, and/or thickness/strength of attachments for the implant. The enhanced control over both linear/translational and rotational movement applied to the implant, and the pressure applied to the implant provide more accurate diagnostic results compared to other approaches that, for example, only test a single direction of movement. Further features that may be included in some example implant testing systems of this disclosure, such as the various sensors described in more detail below, also improve diagnostic result accuracy by providing reliable and precise feedback of the movement and pressure applications to the implant when using the testing system.

FIG. 3 shows an example implant testing system 300 for testing abrasion effects and attachment strength for an implant under test. As used herein, the reference to proximal or distal tendons represents one example implantation configuration that is able to be tested by the disclosed systems and methods, although other configurations of implants and implant arrangements may be used similarly. For example, where described as proximal or distal tendons, the disclosure also applied to proximal and distal ends of other simulated musculoskeletal components (e.g., tendons, muscles, etc.).

The testing system 300 includes a first, linear (e.g., lateral and/or translational) actuator 302 configured to move a simulated proximal tendon 308 in a translational direction. The linear actuator may be any suitable actuating system, including but not limited to a motor with a lead screw, a pneumatic system, a piezoelectric “voice coil” motor, etc. The simulated proximal tendon 308 may be formed of a material having shared properties (e.g., resiliency, thickness, flexibility, weight, texture, etc.) with real tendons of a subject's body. In other examples, the simulated proximal tendon 308 may be formed of and/or otherwise include portions of a real tendon. The simulated proximal tendon 308 may be coupled to the linear actuator 302 via one or more pulleys (e.g., pulley 304 and pulley 306) to reduce strain on the tendon and/or increase translational power of the actuator. For example, the simulated proximal tendon 308 may traverse a path from the linear actuator around a pulley system comprising the pulleys 304 and 306 to the implant. The simulated proximal tendon 308 may be coupled to simulated distal tendons 313 (e.g., formed of the same or similar material as the simulated proximal tendon) via an implant 310 that is being tested by the testing system. Examples of attachment between the implant 310 and the tendons 308 and 313 are described above with respect to FIGS. 1 and 2.

The implant 310 (and portions of the tendons 308 and 313) is housed in an enclosure 312. The enclosure 312 may be configured to simulate the environment of the implant, such as tissue that surrounds the implant when implanted in a subject's body. For example, enclosure 312 may include a base layer of simulated tissue material (e.g., silicone) and a top layer of simulated tissue material, where the implant 310 is positioned between (and contacting inward-facing surfaces of) the base layer and the top layer. In some examples, the top layer may be formed of the same type of material as the base layer, or may be formed of a material having similar properties to the material used in the base layer. In other examples, the top layer and the base layer may be formed of material having some differences in properties, such as material configured to simulate different types of tissue (e.g., tissue that is expected to be present on top of the implant versus tissue that is expected to be present below the implant when implanted in a subject's body). Portions of the inward-facing surfaces of the top layer and the base layer of the enclosure 312 that do not contact the implant or portions of the simulated tendons may contact one another in some examples, forming at least a partial seal around the implant. In some examples, the top layer of simulated tissue material may be thinner than the base layer. For example, the top layer may be formed as a thin flap configured to correspond to the thickness of a dermal layer on top of the implant when implanted in a subject's body.

The enclosure 312 may include a relatively rigid, partial outer shell configured to secure the top layer of simulated tissue to the base layer of simulated tissue with the implant sandwiched between the top layer and the base layer. The shell may include tightening mechanisms (described in more detail below) to allow an adjustment of the tautness of the top layer and/or a tightness to which the top layer is secured to the base layer, and therefore adjustment of a pressure applied to the implant from the top layer and/or base layer. In some examples, the tightening mechanisms may allow for different levels of pressure at different regions of the enclosure to control a distribution of pressure across the implant.

The simulated distal tendons 313 are attached at a distal end (e.g., in an opposite direction of the implant from the linear actuator 302) to respective springs 318a and 318b via a pulley system including pulleys 314 and 316. For example, the simulated distal tendons may traverse a path from the tensioner around a pulley system comprising pulleys 314 and 316 to the implant. In order to simulate rotational movement, the springs 318a and 318b may be controlled to have a different stiffness from one another, where an amount of difference in stiffness, as a function of an amount of translational force applied by the linear actuator 302, correlates to an amount of rotational force or movement applied to the implant. For example, when the linear actuator 302 is controlled to pull on the simulated proximal tendon 308, the force of that movement is translated through the implant to the distal tendons 313, which causes the distal tendons 313 to pull on the springs 318a and 318b respectively. The distal tendon that is attached to the stiffer spring (in the example where the springs are controlled to have a different stiffness) will allow for less movement toward the linear actuator 302 than the distal tendon that is attached to the less stiff spring, resulting in a rotational movement of the implant. Although two springs (and two simulated distal tendons) are shown in the example of FIG. 3, it is to be understood that in alternative examples, a single spring and a single simulated distal tendon may be used for the implant testing system 300. In such alternative examples, translational force applied by the linear actuator 302 causes linear motion of the simulated proximal tendon 308, which is transferred to motion in the single simulated distal tendon to stretch the single spring. In this way, the single spring may serve as a tensioner configured to apply linear force to the single simulated distal tendon to stimulate translational movement of an implant against the simulated tissue responsive to the translational force applied to the simulated proximal tendon 308.

As described above, the implant testing system 300 may include one or more sensors to provide measurements relating to various forces. For example, a linear load sensor 320 may be connected to an output of the linear actuator 302 to measure force exerted on the proximal tendon 308 at the location of the sensor. Spring load sensors 322a and 322b may be used to measure load forces for each of the spring 318a and 318b, respectively. In alternative examples where the implant testing system 300 only includes a single spring coupled to a single simulated distal tendon as described above, a single spring load sensor may be used to measure load forces from the single spring. One or more pressure sensors 324 may be provided in the enclosure 312 (e.g., on or under the implant 310 and/or distributed in the top and/or base layer of simulated tissue; examples of pressure sensors that may be used in testing system 300 are described in more detail below) to measure pressure forces on or around the implant 310. The testing system 300 may also include one or more control devices 326 configured to adjust operation of one or more automated components of the testing system (e.g., the linear actuator 302, tightness adjustment mechanisms of the enclosure 312 and/or stiffness adjustment mechanisms of the springs 318a and 318b in examples where such mechanisms are automatically controllable, etc.) and/or to receive output from one or more of the above-described sensors. In some examples, the output of one or more of the sensors may be used to adjust the control devices 326 to cause one or more associated automated components of the testing system to be adjusted to produce a desired force. It is to be understood that multiple control devices, controllers, and/or other computing systems may be coupled to one or more components of the implant testing system 300 in some examples. For example, different types of sensors may be coupled to different controllers and/or to respective intermediary controller(s) (e.g., configured to perform pre-processing on output data from the sensors) that are coupled to a centralized computing system (e.g., configured to perform additional processing on the output data from the sensors/intermediary controller(s) and/or to generate a user interface (e.g., a graphical user interface) to present the output to a user of the implant testing system 300.

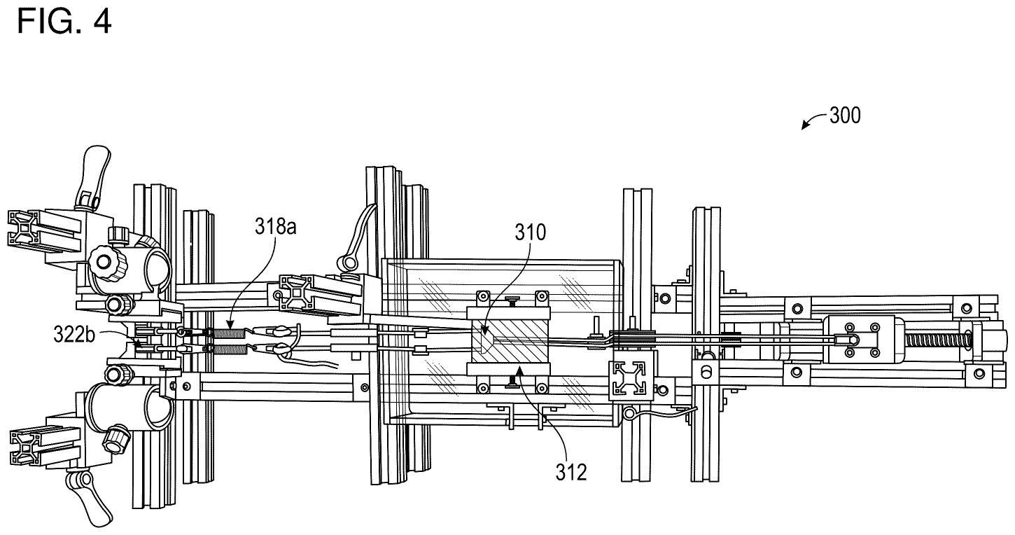

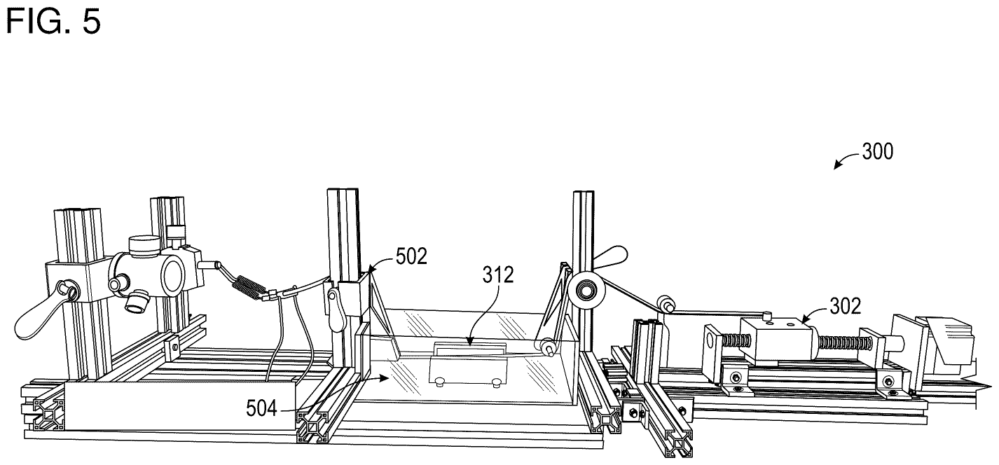

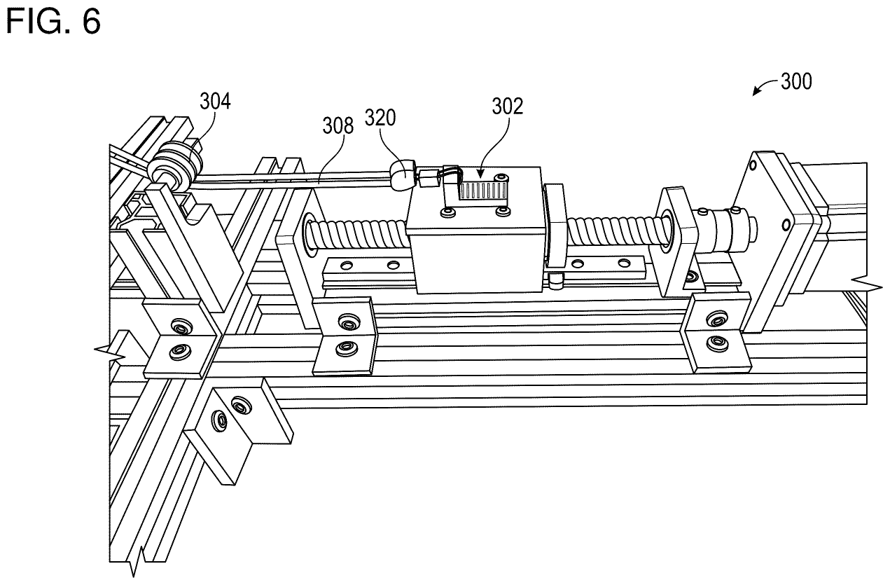

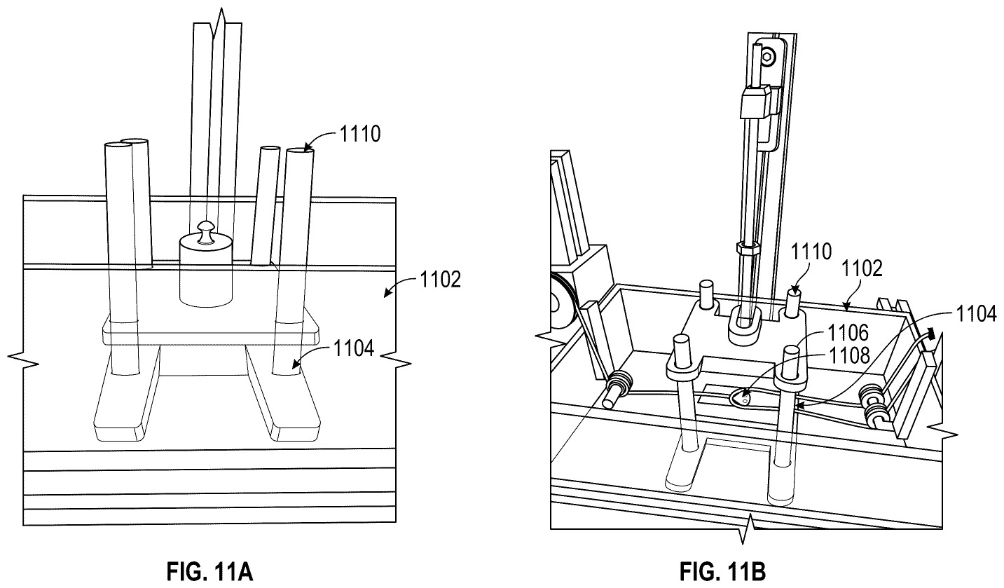

FIGS. 4-6 show different views of the testing system 300 and/or portions thereof. For example, FIG. 4 shows a top view of the testing system 300, FIG. 5 shows a side view of the testing system 300, and FIG. 6 shows an example detail view of the linear actuator 302 and related connections of the testing system 300. In FIG. 5, the pulleys 304, 306, 314, and 316 are collectively referenced as a pulley system 502. Further in FIG. 5, a solution bath 504 is visible, in which the enclosure 312 is placed to simulate an environment of the implant. The solution bath 504 may include a container of saline or other solution filled to a level at which the top and base layers of the enclosure 312 are submerged. Additional details of example solution baths are described below with respect to FIGS. 11A and 11B.

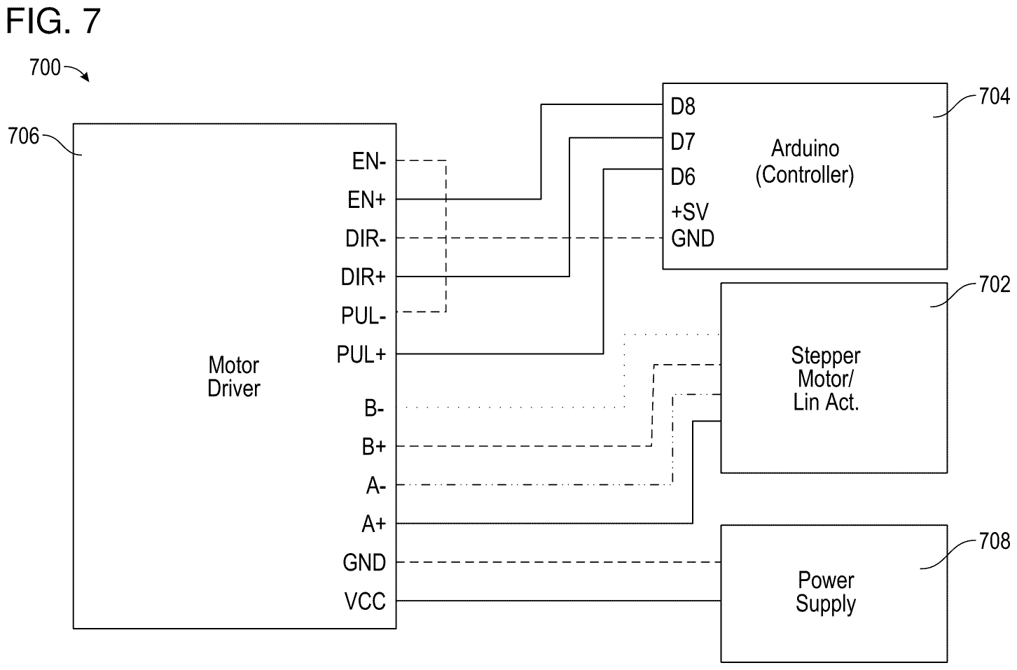

FIG. 7 is an example circuit diagram for components of a linear actuator 700 for use in an implant testing system. The linear actuator 700 may be an example of and/or include the linear actuator 302 of FIG. 3. The linear actuator 700 may act as a muscle pulling on tendons. The actuator includes a stepper motor 702 with a linear screw that is set to move the implant a targeted distance (e.g., a distance of 40 mm [˜4000 steps] at roughly 3 seconds per cycle, in some examples). Both the distance and the speed can be changed via programming of a controller 704. An attachment (e.g., 3D printed in some examples) on the linear actuator 700 connects to a string (e.g., a simulated proximal tendon) going through an associated implant testing system (e.g., implant testing system 300 of FIG. 3). As described above, a force sensor may be provided on this proximal string in order to measure an initial force applied on the testing system.

In some examples, a configuration of the linear actuator 700 includes a stepper motor/linear actuator 702 (e.g., a FUYU FSL40 Linear Guide/Actuator), connected to a motor driver 706 (e.g., a Microstep T-4045-A1 motor driver), connected to a power supply 708 (e.g., a 36V, 9.7A DC power supply), all controlled by a controller 704 (e.g., an Arduino circuit board). In some examples, the step size on the motor is set to ¼ step per cycle and the current input is set to 2.8 A, however, the step size and current input can be further adjusted on the motor driver.

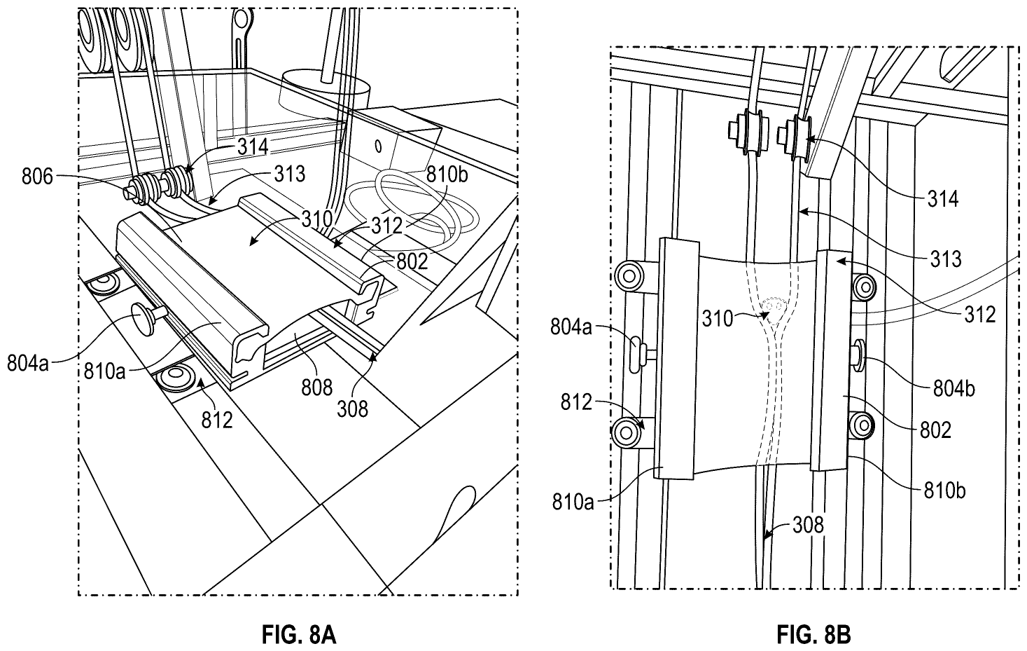

FIGS. 8A-10 show detailed examples of enclosures (or components of enclosures) for holding an implant under test for an implant testing system (e.g., implant testing system 300 of FIG. 3). FIG. 8A shows a detailed perspective view of the implant testing system 300 of FIG. 3 and FIG. 8B shows a detailed top view of the implant testing system 300 of FIG. 3, each including the enclosure 312, simulated proximal tendon 308, simulated distal tendons 313, implant 310, and pulley 314. Further visible in the views of FIGS. 8A and 8B are a rigid shell 802 of the enclosure 312, and tightening mechanisms 804a and 804b for clamps 810a and 810b, respectively. As described above, the tightening mechanisms 804a and 804b are configured to allow for manual (or automated, in some examples) adjustment of the tautness of a top layer 806 of simulated tissue over the implant and a base layer 808 of simulated tissue. The top layer 806 and base layer 808 may form a sandwich of a test bed (e.g., formed from two pieces of silicone, such as EcoFlex 30 silicone in a non-limiting example), such that the implant 310 (and portions of the simulated tendons 308 and 313) is placed between the top layer and the base layer. In a non-limiting example, the base layer 808 may comprise a bottom block of silicone that is 40×80×15 mm, while the top layer 806 may comprise a thin film or sheet of 2.5 mm thickness tensioned over the top of the base layer and the implant 310. In the illustrated example, the top layer 806 is tensioned by adjusting a screw position (e.g., of tightening mechanisms 804a and 804b, respectively) on custom clamps on either side (e.g., opposing sides) of the sandwich (e.g., clamps 810a and 810b of the rigid shell 802). The clamps are moveable (e.g., configured to slide) along rails 812 of a bottom mold of the enclosure 312 and allow for easy fine tuning of tension.

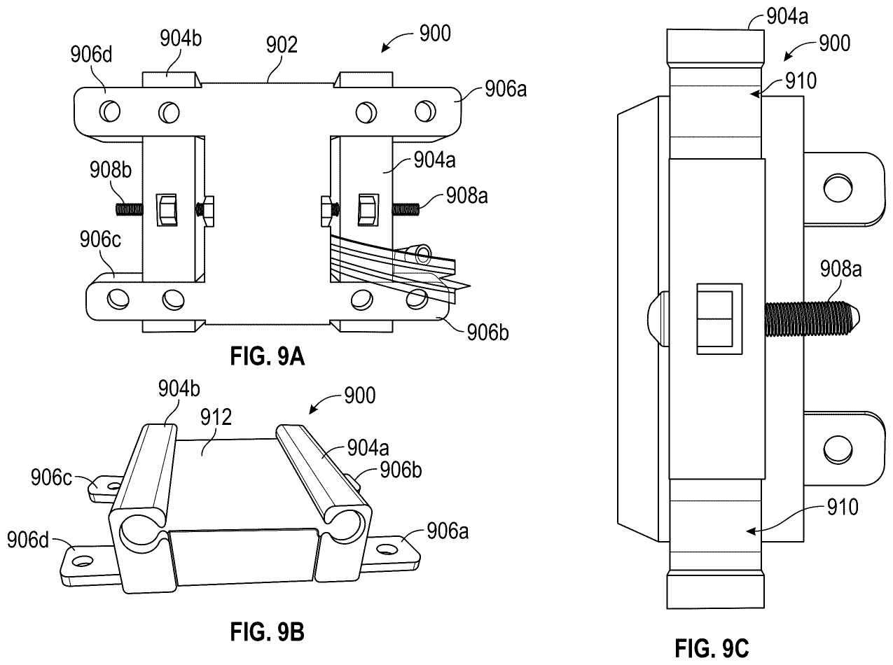

FIGS. 9A-9C show different views of an example enclosure 900, including a bottom view shown in FIG. 9A, side perspective view shown in FIG. 9B, and a detailed bottom view shown in FIG. 9C of a disassembled clamp. In FIGS. 9A-9C, a rigid shell 902 of the enclosure 900 is shown, including rails 906a-906d (e.g., a first pair of rails 906a and 906b extending from a first side of the enclosure and a second pair of rails 906c and 906d extending from a second, opposite side of the enclosure) on which clamps 904a and 904b are configured to slide responsive to adjustment of a respective tightening mechanism 908a and/or 908b. As shown in FIG. 9C, the clamps (e.g., clamp 904a in the illustrated example) include grooves 910 on either side of the tightening mechanism (tightening mechanism 908a in the illustrated example) to allow the clamp to slide on respective rails (e.g., rails 906a and 906b, respectively, for the illustrated example clamp) when adjusting a tautness of a top layer 912 of simulated tissue. In a non-limiting example, the top layer 912 is a slab of silicone that is approximately 46×86×2.5 mm with ends consisting of 10 mm\hat{ }2 cylinders that slide into the clamps 904a and 904b.

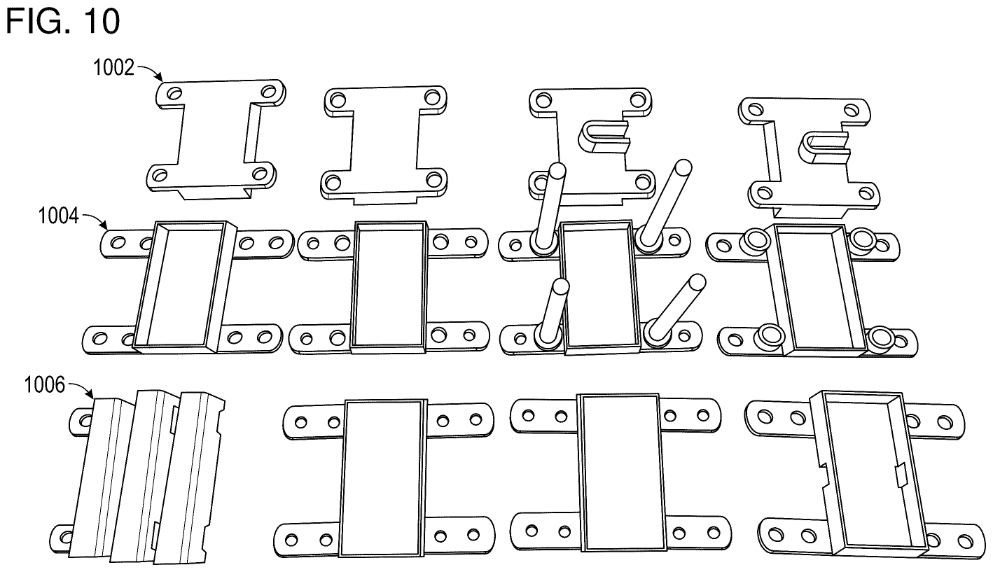

FIG. 10 shows different exemplar disassembled enclosures that may be used in an implant testing system, such as implant testing system 300 of FIG. 3, once assembled. An example weighted topper 1002 is shown, which may be coupled to the top of an example shell 1004 of an enclosure (described in more detail below with respect to FIGS. 11A-11B) to provide a custom downward force on an implant housed in the shell. In additional or alternative examples, where the shell 1004 is configured to house a base layer of simulated tissue over which a top layer of simulated tissue is stretched, the top layer of simulated tissue may be stretched using clamps 1006 configured to slide along rails of the shell, as described in more detail with respect to the examples above. The above example components of enclosures (and weighted toppers) may include 3D printed PLA casings that attach to a solution bath, described in more detail below with respect to FIGS. 11A and 11B.

FIGS. 11A and 11B show example views (e.g., a side perspective view in FIG. 11A and a top perspective view shown in FIG. 11B) of a solution bath 1102 into which an enclosure 1104 housing an implant 1108 to be tested by an implant testing system, such as implant testing system 300 of FIG. 3, is submerged. As shown in FIG. 11B, a topper 1106 is installed over a top of the enclosure 1104 (e.g., spaced from the implant 1108). In some examples, the topper 1106 may be lowered and tightened over the implant (e.g., sliding on poles 1110, which may be metallic in some examples) to provide an additional or alternative source of downward pressure (e.g., in addition to or as an alternative to pressure applied via tension of a top layer of simulated tissue, as described in more detail in the above examples). In some examples, one or more weights are added to the topper 1106 to provide the downward force. The solution bath 1102 that holds the enclosure 1104 may be made of any suitable material to retain a solution. In a non-limiting example, the solution bath 1102 may be formed of laser-cut acrylic, held together with super glue and silicone caulk (e.g., waterproof glue), which is filled with a saline solution.

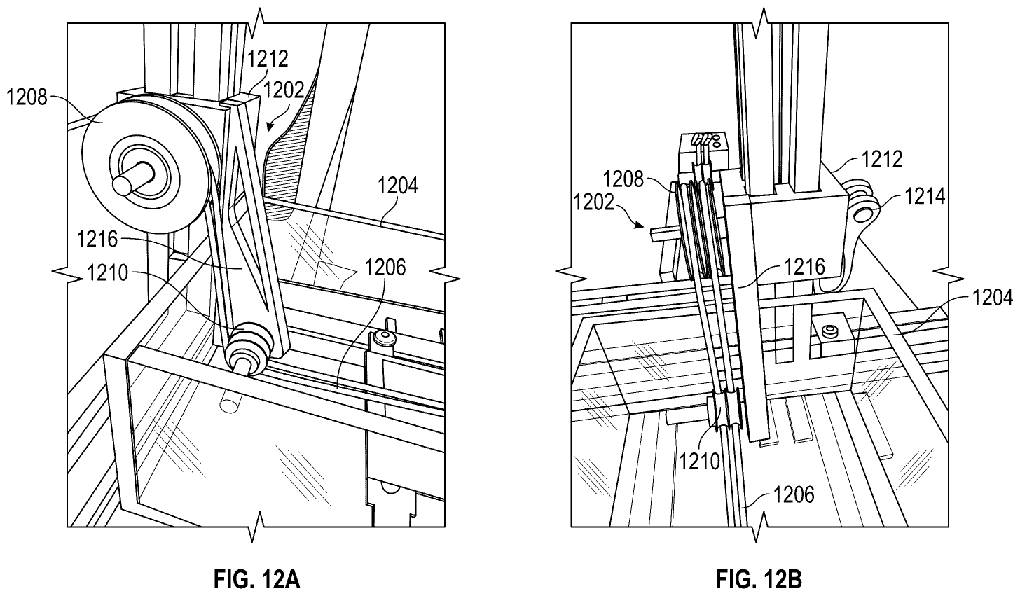

FIGS. 12A and 12B show example detailed views (e.g., a side perspective view in FIG. 12A and a front perspective view shown in FIG. 12B) of a portion of pulley system 1202 usable to redirect simulated tendons for an implant testing system, such as implant testing system 300 of FIG. 3. With the use of a solution bath 1204, simulated tendons 1206 (e.g., simulated proximal tendons) may be directed around an edge of the bath using the pulleys 1208 and 1210. The simulated tendons 1206 go from horizontal to vertical, then back to horizontal. A sliding mechanism 1212 may be used to control the vertical height of the pulley 1208 may include a lever arm 1214 to lock or unlock the sliding ability of the mechanism. A pulley dipper 1216 may be provided to attach the pulley 1210 to the sliding mechanism 1212, and may be printed as a separate piece to allow for modularity and speed of printing in some examples, being attached to the slider with an adhesive such as super glue.

The bottom pulley 1210 may be fully plastic in some examples in order to allow for submersion in salt water and to reduce material costs. The upper pulley 1208 may be a different diameter and style, and may have the same width as the bottom pulley 1210 (e.g., 3/16 inches in some examples) to be roughly the same size as the simulated tendons 1206. In other examples, other diameters may be used. The upper pulley 1208 may have a ball bearing since it is not configured to come into contact with the saline. The upper pulley 1208 may include a shaft and shaft caps that are press fit and modular to accommodate changes in pulley designs.

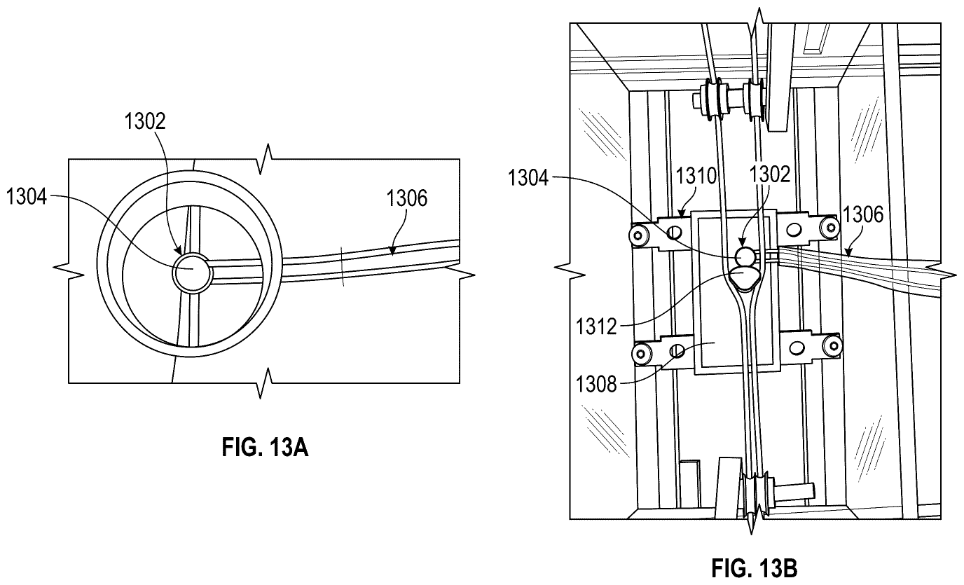

As described above, sensors may be used to measure various forces experienced at different portions of the testing environment of an implant testing system, such as implant testing system 300 of FIG. 3. FIGS. 13A and 13B show examples of pressure sensors that may be used in proximity to an implant under test in order to measure pressure applied on or around the implant. FIG. 13A shows a detailed view of an example pressure sensor 1302, including a sensing area surface 1304 and leads 1306, which terminate in connectors to allow readings from the sensing area surface 1304 to be output to a downstream controller. The leads 1306 may supply drive voltage from the controller (not shown in FIGS. 13A and 13B) to a resistive element of the sensing area surface 1304, and a differential across the leads may be measured to determine changes in resistance that correlate to force load applied to the sensing area surface 1304. In a non-limiting example, the sensor 1302 may include a TekScan FlexiForce 1 lb pressure sensor, with a sensing area of 285.3 mm\hat{ }2. The sensor 1302 may be thin, small, and flexible. FIG. 13B shows an example positioning of the sensor 1302 in an implant testing system, such as implant testing system 300 of FIG. 3. For example, the sensor 1302 may be positioned on top of (or embedded in) a base layer 1308 of simulated tissue in an enclosure 1310, and an implant 1312 may be positioned on top of the sensing area surface 1304 of the sensor 1302. In other examples, the sensor 1302 may be positioned on top of the implant 1312 and under a top layer of simulated tissue (examples of which are described above). In still further additional or alternative examples, a plurality of sensors such as sensor 1302 may be distributed in different locations on or between the top and/or base layers.

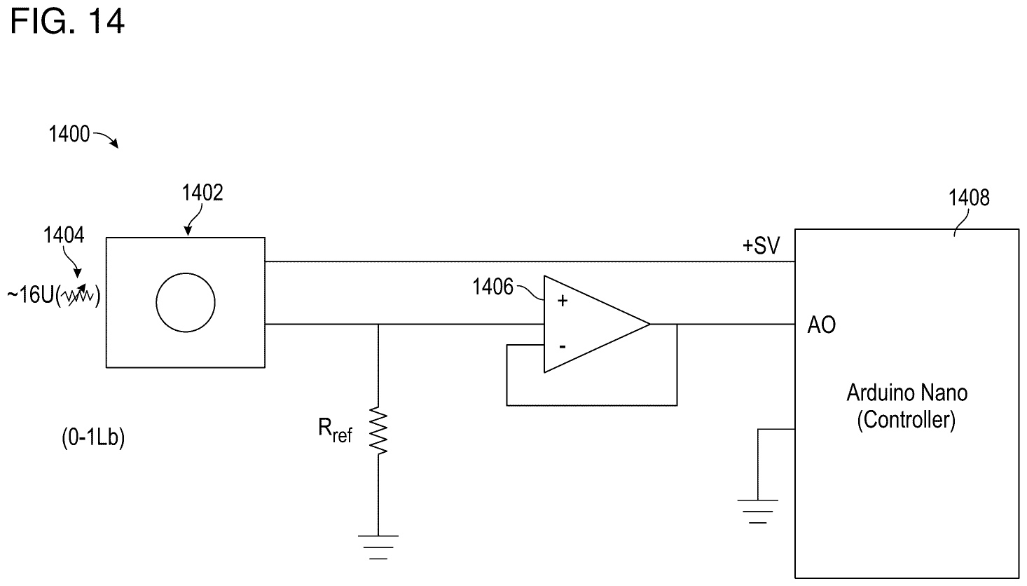

FIG. 14 shows an example diagram of a circuit 1400 for load sensing with a pressure sensor 1402, an example of which is described in more detail above with respect to sensor 1302 of FIGS. 13A and 13B. The circuit 1400 includes a voltage divider 1404 and a buffer amp 1406, attached to a controller 1408.

The sensor 1402 may be recalibrated after each alteration to the test bed in which it is deployed. Any movement or adjustments will affect the readings of the sensor. The sensor may be used for the initial calibration of applied pressure onto a tested implant. In order to perform the calibration, the sensor may be firmly placed in the sandwich (e.g., between top and base layers of simulated tissue, as described above) and the implant may be centered above the sensor. A known weight (e.g., a 20 g weight) may be placed on top of the implant and the voltage output measured by the sensor may be read from an output connected to the controller after a threshold wait time (e.g., 5 seconds, to allow for stabilization of the weight). The weight may be removed and reapplied multiple times (e.g., ten times) and an average output may be determined. In some examples, different weights may be applied and average output determined in order to generate a curve that shows different pressures corresponding to different weights. In some examples, a range of the output voltage can be altered by the reference resistor (R_ref in FIG. 14) or by changing the buffer amplifier into a non-inverting amplifier. As an example, a conversion of gram weight measurements to pressure may be calculated as follows:

$$P\_ 100 = F / A = ( 0.1 * 9.8 ) / ( 280 mm \hat{} 2 ) = 3500 N / m \hat{} 2 \\ P\_ 20 = ( 0.02 * 9.8 ) / ( 280 mm \hat{} 2 ) = 700 N / m \hat{} 2.$$

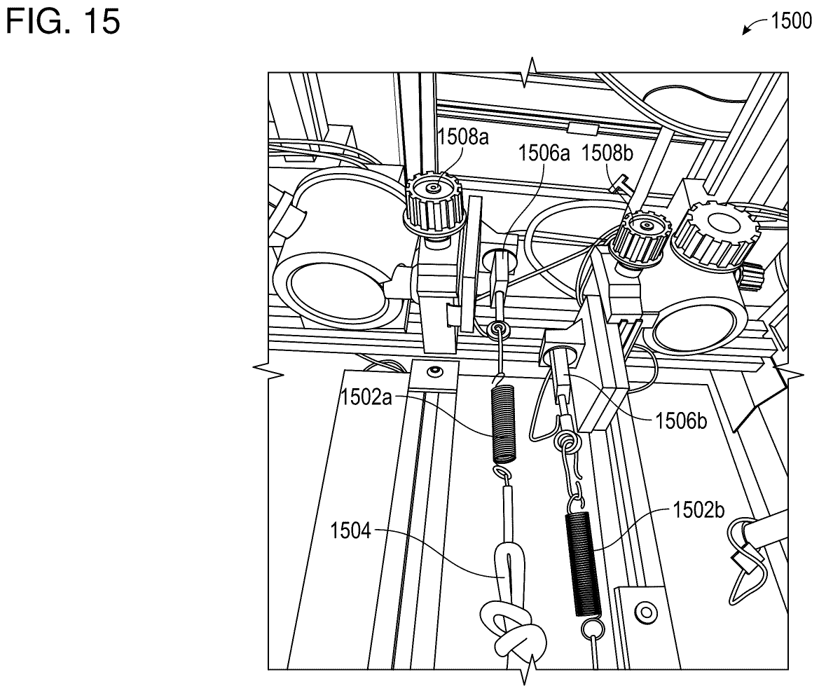

Another example sensor for an implant testing system includes distal load sensors, such as sensors attached to springs at an opposite end of the testing system from a linear actuator (examples of which are described in more detail above with respect to implant testing system 300 of FIG. 3). For example, FIG. 15 shows an example portion of an implant testing system 1500 including springs 1502a and 1502b connected to respective simulated distal tendons 1504. The springs 1502a and 1502b may be examples of springs 318a and 318b of FIG. 3. Load sensors 1506a and 1506b may be respectively coupled to distal ends of the springs 1502a and 1502b, at an opposite end of a linear actuator (not shown in FIG. 15) generating translational force on the simulated distal tendons 1504. In a non-limiting example, the sensors 1506a and 1506b may be 5-pound FUTEK force sensors. In some examples, the sensors 1506a and 1506b are attached to camera mounts 1508a and 1508b to allow for modularity and adjustments of the sensors. The sensors may run through a MATLAB code executing on a controller or other computing system that converts change in voltage to change in force, in an analogous manner to the pressure sensors described above.

### VI. Additional Examples

The following examples are provided to illustrate additional or alternative examples of implant testing systems. These examples should not be construed to limit the disclosure to the particular features or embodiments described. It is to be understood that the features of the additional examples may be combined with one or more of the features of the other examples described herein without departing from the scope of this disclosure.

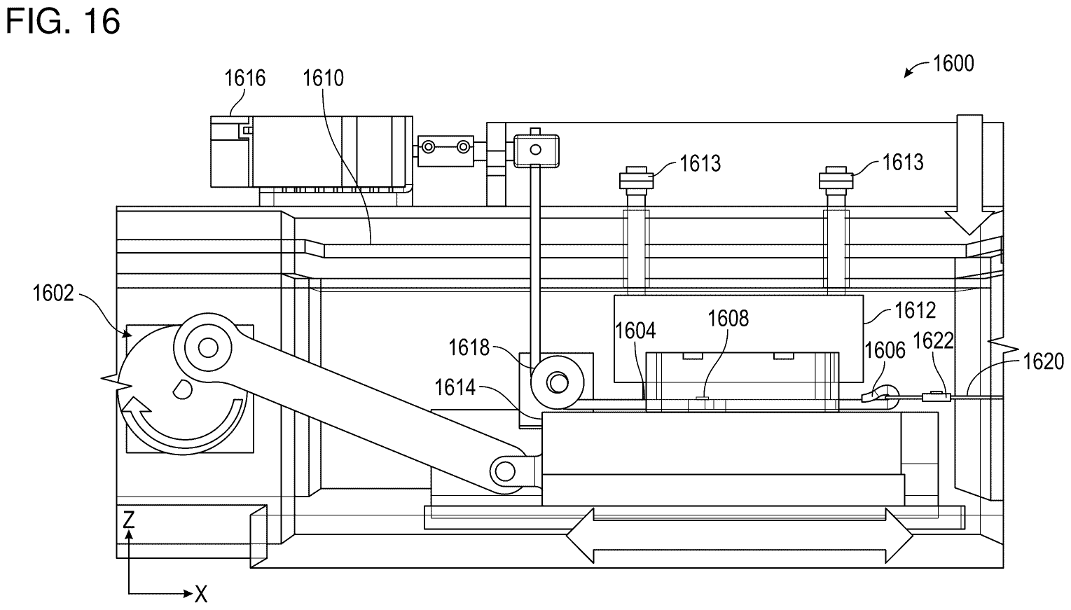

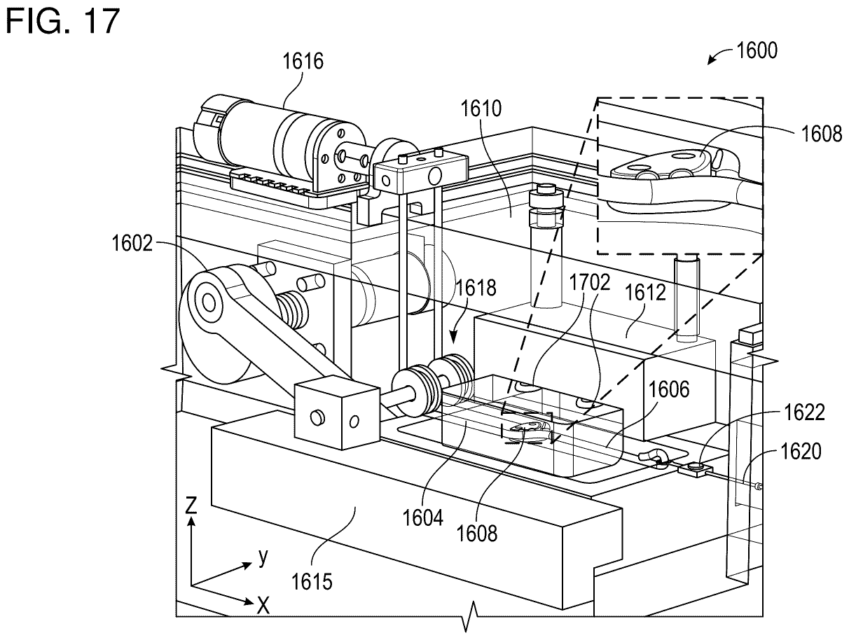

FIGS. 16 and 17 show different views of another example implant testing system 1600. FIG. 16 shows a schematic side view of the example implant testing system 1600 and FIG. 17 shows a schematic side perspective view of a rear portion of the implant testing system 1600. The implant testing system 1600 includes a rotary to linear motion generator 1602, configured to generate tensioning translational force on simulated distal tendons 1604, which are coupled to simulated proximal tendon 1606 via an implant 1608. Similar to the examples described above with respect to FIGS. 11A-11B, the implant 1608 may be submerged in a solution bath 1610 (e.g., a testbed filled with 0.9% saline solution in some examples) subjected to a downward force applied by a weighted block 1612 of simulated tissue (e.g., weighted at least in part by removable weights 1613), which simulates internal pressure. A tray 1614 of tissue that is configured to slide due to output of the rotary to linear motion generator 1602 on a linear rail 1615 may provide for translational movement simulation (e.g., simulating implant translation). A rotary motor or actuator 1616 may be connected to the simulated distal tendons 1604 via a pulley system 1618 to simulate rotational movement of the implant 1608. A tensioner 1620 may be coupled to an end of the simulated proximal tendon 1606 and a load sensor 1622 may be connected therebetween to measure an amount of force exerted on the simulated proximal tendon 1606 in that location. As shown in FIG. 17, pressure sensors 1702 may be included in the weighted block 1612 to measure an amount of force applied to the implant 1608 from the weighted block.

### VII. Method for Testing Implants and Method of Manufacturing Testing System

A. Method for Testing

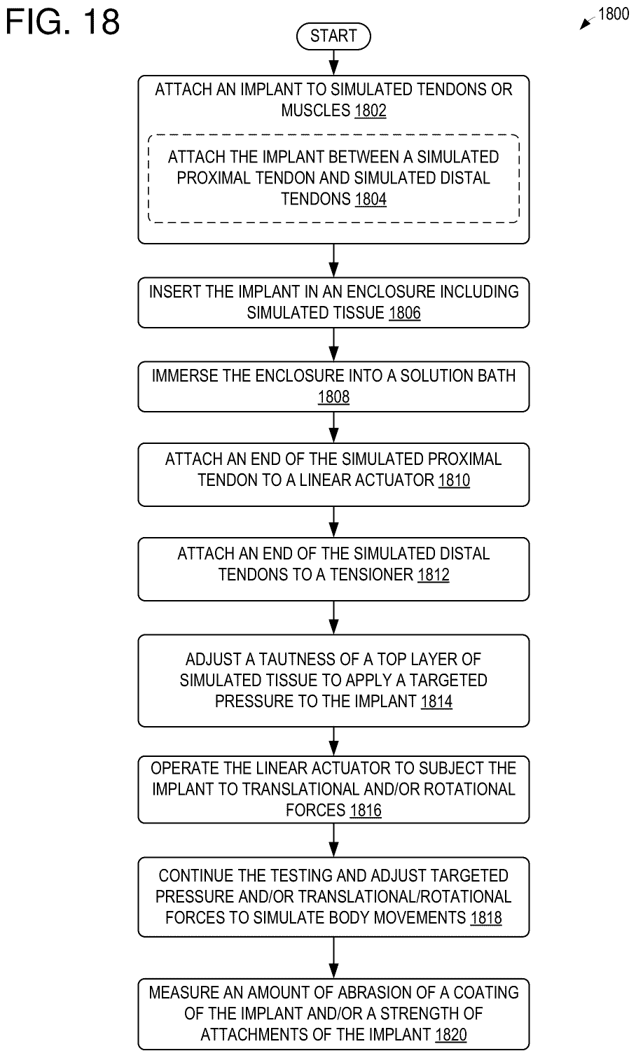

Implants may be tested using any of the above-described examples of implant testing systems, such as implant testing system 300 of FIG. 3. An example method 1800 of testing an implant using the implant testing system is shown in FIG. 18. It is to be understood that the operations of method 1800 may be performed in any suitable order, including performing some operations simultaneously or at overlapping times. At 1802, the method includes attaching an implant to simulated tendons or muscles. For the remainder of the disclosure of the method 1800, reference will be made to simulated tendons for exemplary purposes, however, it is to be understood that similar operations may be performed with other arrangements in which the implant is attached to simulated muscles or other body parts/tissues. For example, as indicated at 1804, the implant may be attached between a simulated proximal tendon and simulated distal tendon(s), examples of which are described above in various configurations, including implant testing system 300 of FIG. 3. In some examples, the implant may be attached to the simulated tendon(s) via one or more sutures or other attachment mechanisms (where the tendon may be wrapped around the implant and sutured to itself or wrapped around the implant's groove so that the tendon can slide on the tendon), as described in more detail above, such as in reference to FIGS. 2A-2C.

At 1806, the method includes inserting the implant in an enclosure including simulated tissue. For example, as described in more detail above, such as with respect to FIGS. 8A and 8B, the implant may be inserted between two layers of simulated tissue: a base layer and a top (e.g., thinner) layer. At 1808, the method includes immersing the enclosure into a solution bath. For example, as described above, the enclosure may be submerged or partially submerged in a bath of saline solution.

At 1810, the method includes attaching an end (e.g., an end opposite of the implant) of the simulated proximal tendon to a linear actuator. As shown in FIG. 3 and other examples, the simulated proximal tendon may be connected to the linear actuator via one or more pulleys. At 1812, the method includes attach an end (e.g., an end opposite of the implant) of the simulated distal tendons to respective tensioners, such as springs. As shown in FIG. 3 and in other examples, the simulated distal tendons may be connected to the tensioners via one or more pulleys.

At 1814, the method includes adjusting the tautness of the top layer of the simulated tissue in the enclosure to apply a targeted pressure to the implant. The targeted pressure may be determined to be reached based on an output of one or more pressure sensors located in the enclosure, as described above.

At 1816, the method includes subjecting the implant to translational and/or rotational forces by operating the linear actuator and adjusting a stiffness of the tensioners. As described above, the forces may be adjusted to reach targeted load forces on the implant based on feedback provided by one or more load sensors.

At 1818, the method includes continuing the testing and adjusting the targeted pressure and/or the translational and/or rotational forces applied to the implant to simulate body movements (e.g., typical body movements) for a testing period. At 1820, the method includes measuring an amount of abrasion of a coating of the implant and/or a strength of attachments (e.g., sutures or other attachment mechanisms) between the implant and the simulated tendons after the testing period is complete. In some examples, the testing period may be determined to be complete after a specified period of time, a specified number of movements, or when the implant has reached a specified level of distress (e.g., a threshold amount is abrased and/or an attachment is frayed to a threshold amount or broken).
B. Making Disclosed Embodiments

In some examples, the implant testing systems and/or corresponding components described herein may be made using any method now known or hereafter developed as will be understood by a person of ordinary skill in the art by methods including, but not limited to, 3D printing, Computer Numerical Control (CNC) Milling and/or Shape Deposition Manufacturing (SDM).

### VIII. Computing Environment

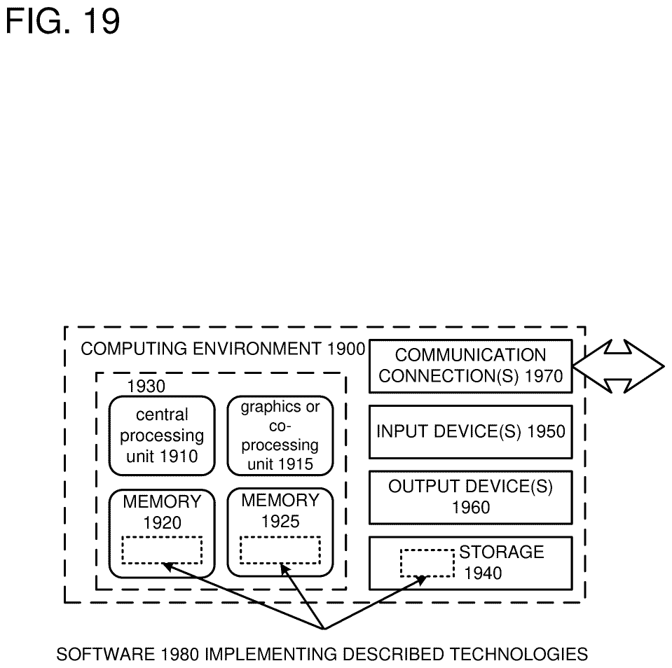

FIG. 19 depicts a generalized example of a suitable computing environment 1900 in which the described innovations may be implemented. For example, the computing environment 1900 and/or one or more components therein may include and/or be included in any of the described controllers, control devices, and/or computing systems described herein, such as control device 326 of FIG. 3. The computing environment 1900 is not intended to suggest any limitation as to scope of use or functionality, as the innovations may be implemented in diverse general-purpose or special-purpose computing systems. For example, the computing environment 1900 can be any of a variety of computing devices (e.g., desktop computer, laptop computer, server computer, tablet computer, etc.).

With reference to FIG. 19, the computing environment 1900 includes one or more processing units 1910, 1915 and memory 1920, 1925. In FIG. 19, this basic configuration 1930 is included within a dashed line. The processing units 1910, 1915 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 19 shows a central processing unit 1910 as well as a graphics processing unit or co-processing unit 1915. The tangible memory 1920, 1925 may be volatile memory (e.g., registers, cache, RAM), non-volatile memory (e.g., ROM, EEPROM, flash memory, etc.), or some combination of the two, accessible by the processing unit(s). The memory 1920, 1925 stores software 1980 implementing one or more innovations described herein, in the form of computer-executable instructions suitable for execution by the processing unit(s).

A computing system may have additional features. For example, the computing environment 1900 includes storage 1940, one or more input devices 1950, one or more output devices 1960, and one or more communication connections 1970. An interconnection mechanism (not shown) such as a bus, controller, or network interconnects the components of the computing environment 1900. Typically, operating system software (not shown) provides an operating environment for other software executing in the computing environment 1900, and coordinates activities of the components of the computing environment 1900.

The tangible storage 1940 may be removable or non-removable, and includes magnetic disks, magnetic tapes or cassettes, CD-ROMs, DVDs, or any other medium which can be used to store information in a non-transitory way and which can be accessed within the computing environment 1900. The storage 1940 stores instructions for the software 1980 implementing one or more innovations described herein.

The input device(s) 1950 may be a touch input device such as a keyboard, mouse, pen, or trackball, a voice input device, a scanning device, or another device that provides input to the computing environment 1900. The output device(s) 1960 may be a display, printer, speaker, CD-writer, or another device that provides output from the computing environment 1900.

The communication connection(s) 1970 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well-known in the art are omitted. For example, it should be understood that the disclosed technology is not limited to any specific computer language or program. For instance, aspects of the disclosed technology can be implemented by software written in C++, Java, Perl, any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

### IX. Example Methods, Apparatus, and Systems

In a first example, an apparatus for testing an implant in a simulated environment comprises a linear actuator, a tensioner comprising a spring, a simulated proximal tendon coupled to the linear actuator, wherein the linear actuator is configured to apply a translational force on the simulated proximal tendon, a simulated distal tendon coupled to the spring, wherein an implant is couplable between the simulated proximal tendon and the simulated distal tendon, an enclosure comprising a first, base layer of simulated tissue and a second, top layer of simulated tissue, wherein an implant is positionable between the first, base layer and the second, top layer, and one or more sensors configured to measure an amount of force applied when an implant is positioned in the apparatus.

A second example includes the first example, and further includes the apparatus, wherein the spring is a first spring and wherein the tensioner further comprises a second spring configured to have a different amount of stiffness from the first spring in order to generate a rotational force that is applied when an implant is positioned in the apparatus responsive to application of the translational force by the linear actuator.

A third example includes one or both of the first and second examples, and further includes the apparatus, wherein the spring is a first spring, wherein the tensioner further comprises a second spring, and wherein the one or more sensors comprises a first load sensor coupled to the first spring and a second load sensor coupled to the second spring.

A fourth example includes one or more of the first through third examples, and further includes the apparatus, wherein, responsive to application of the translational force on the simulated proximal tendon, linear motion of the simulated proximal tendon is transferred to motion in the simulated distal tendon and stretches the spring.

A fifth example includes one or more of the first through fourth examples, and further includes the apparatus, wherein the one or more sensors comprises a load sensor couple to the spring.

A sixth example includes one or more of the first through fifth examples, and further includes the apparatus, wherein the one or more sensors comprises a load sensor coupled to an output of the linear actuator or included in the linear actuator.

A seventh example includes one or more of the first through sixth examples, and further includes the apparatus, wherein the second, top layer of simulated tissue is thinner than the first, base layer of simulated tissue.

An eighth example includes one or more of the first through seventh examples, and

further includes the apparatus, wherein the enclosure comprises a first clamp and a second clamp positioned on opposite sides of the enclosure, and wherein a tautness of the second, top layer of simulated tissue is adjusted by changing a distance between the first clamp and the second clamp using a tightening mechanism.

A ninth example includes one or more of the first through eighth examples, and further includes the apparatus, wherein the enclosure further comprises a first pair of rails extending from a first side of the enclosure and a second pair of rails extending from a second side of the enclosure, and wherein the first clamp is configured to move along the first pair of rails and the second clamp is configured to move along the second pair of rails responsive to adjustment of the tightening mechanism.

A tenth example includes one or more of the first through ninth examples, and further includes the apparatus, wherein the one or more sensors comprises a pressure sensor positioned between the first, base layer of simulated tissue and the second, top layer of simulated tissue.

An eleventh example includes one or more of the first through tenth examples, and further includes the apparatus, further comprising a solution bath, wherein the enclosure is at least partially submerged in the solution bath.

A twelfth example includes one or more of the first through eleventh examples, and further includes the apparatus, wherein the simulated proximal tendon traverses a path from the linear actuator around a pulley system to the implant.

A thirteenth example optionally includes one or more of the first through twelfth examples, and further includes the apparatus, wherein the simulated distal tendon traverses a path from the tensioner around a pulley system to the implant.

In a fourteenth example, an apparatus for testing an implant coupled to a simulated musculoskeletal component comprises a base layer of simulated tissue positionable under a bottom surface of an implant, a top layer of simulated tissue positionable over a top surface of an implant, a linear actuator configured to generate and apply translational force to a proximal end of the simulated musculoskeletal component when an implant is positioned in the apparatus to simulate translational movement of the implant against the simulated tissue, and a tensioner configured to apply linear or differential force to one or more distal ends of the simulated musculoskeletal component to simulate translational or rotational movement of an implant against the simulated tissue responsive to the translational force applied to the proximal end of the simulated musculoskeletal component.

A fifteenth example includes the fourteenth example, and further includes the apparatus, further comprising one or more sensors configured to measure an amount of force applied to an implant by one or more of the linear actuator, the tensioner, or the simulated tissue when the implant is positioned in the apparatus.

A sixteenth example includes one or both of the fourteenth and fifteenth examples, and further includes the apparatus, wherein the tensioner is configured to apply linear force to a single distal end of the simulated musculoskeletal component to simulate the translational movement of the implant against the simulated tissue responsive to the translational force applied to the proximal end of the simulated musculoskeletal component.

A seventeenth example includes one or more of the fourteenth through sixteenth examples, and further includes the apparatus, wherein the tensioner comprises one spring and wherein the spring is coupled to the single distal end of the simulated musculoskeletal component.

An eighteenth example includes one or more of the fourteenth through seventeenth examples, and further includes the apparatus, wherein the one or more distal ends comprises a first distal end and a second distal end, and wherein the tensioner is configured to apply differential force to the first distal end and the second distal end to simulate the rotational movement of the implant against the simulated tissue responsive to the translational force applied to the proximal end of the simulated musculoskeletal component.

A nineteenth example includes one or more of the fourteenth through eighteenth

examples, and further includes the apparatus, wherein the tensioner comprises a first spring and a second spring, and wherein the first spring is coupled to the first distal end of the simulated musculoskeletal component and the second spring is coupled to the second distal end of the simulated musculoskeletal component.

A twentieth example includes one or more of the fourteenth through nineteenth examples, and further includes the apparatus, further comprising an enclosure comprising a pair of clamps, wherein the top layer of simulated tissue is secured to opposing sides of the enclosure and positionable over an implant by the pair of clamps.

A twenty-first example includes one or more of the fourteenth through twentieth examples, and further includes the apparatus, wherein the pair of clamps are moveable relative to one another to adjust a tautness of the top layer of simulated tissue over an implant and a resulting pressure applied to an implant by the top layer of simulated tissue when the implant is positioned in the apparatus.

In a twenty-second example, a method of testing an implant comprises attaching an implant between a simulated proximal tendon and one or more simulated distal tendons using one or more attachment mechanisms, inserting the implant in an enclosure including a top layer of simulated tissue and a base layer of simulated tissue, wherein the implant is positioned between the top layer of simulated tissue and the base layer of simulated tissue, attaching a first end of the simulated proximal tendon to a linear actuator, attaching a second end of the simulated distal tendons to a tensioner, operating the linear actuator to apply a translational force to the simulated proximal tendon and, under a first condition in which the one or more simulated distal tendons comprises one distal tendon, to subject the implant to translational forces from the linear actuator and the tensioner, or, under a second condition in which the one or more simulated distal tendons comprises two distal tendons, to subject the implant to translational and rotational forces from the linear actuator and the tensioner, and measuring an amount of abrasion of a coating of the implant or measuring a strength of the attachment mechanisms.

A twenty-third example includes the twenty-second example, and further includes the method, further comprising adjusting a targeted pressure applied over the implant by adjusting a tautness of the top layer of simulated tissue.

A twenty-fourth example includes one or both of the twenty-second and twenty-third examples, and further includes the method, wherein, under the second condition, the tensioner comprises a first spring and a second spring, and wherein the method further comprises adjusting a targeted rotational force applied to the implant by adjusting a differential stiffness of the first spring relative to the second spring.

A twenty-fifth example includes one or more of the twenty-second through twenty-fourth examples, and further includes the method, further comprising immersing the implant in a solution bath.

In a twenty-sixth example, an apparatus for testing an implant in a simulated environment comprises a linear actuator, a tensioner comprising one or more springs, an enclosure comprising: a shell including a plurality of rails extending from opposite sides of the shell, a first clamp and a second clamp respectively positioned over the plurality of rails on the opposite sides of the shell, and a tightening mechanism, wherein a distance between the first clamp and the second clamp is adjustable along the rails using the tightening mechanism, and the apparatus further comprises one or more sensors configured to measure an amount of force applied by the apparatus.

A twenty-seventh example includes the twenty-sixth example, and further includes the apparatus, wherein the enclosure further comprises a first, base layer of simulated tissue disposed in the shell and a second, top layer of simulated tissue extending between the first clamp and the second clamp, wherein an implant is positionable between the first, base layer and the second, top layer, and wherein a tautness of the second, top layer of simulated tissue is adjustable by changing the distance between the first clamp and the second clamp using the tightening mechanism.

A twenty-eighth example includes one or both of the twenty-sixth and twenty-seventh examples, and further includes the apparatus, further comprising a simulated proximal tendon coupled to the linear actuator, wherein the linear actuator is configured to apply a translational force on the simulated proximal tendon, and simulated distal tendons respectively coupled to the one or more springs, wherein an implant is coupleable between the simulated proximal tendon and the simulated distal tendons.

### X. Conclusion

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed technology may be applied, it should be recognized that the illustrated embodiments are only examples and should not be taken as limiting the scope of the disclosure. Rather, the scope of the disclosure is at least as broad as the following claims and equivalents of the recited features. We therefore claim all that comes within the scope of these claims.

We claim:

1. An apparatus for testing an implant in a simulated environment, the apparatus comprising:
a linear actuator;
a tensioner comprising a spring;
a simulated proximal tendon coupled to the linear actuator, wherein the linear actuator is configured to apply a translational force on the simulated proximal tendon;
a simulated distal tendon coupled to the spring, wherein an implant is couplable between the simulated proximal tendon and the simulated distal tendon;
an enclosure comprising a first, base layer of simulated tissue and a second, top layer of simulated tissue, wherein an implant is positionable between the first, base layer and the second, top layer; and
one or more sensors configured to measure an amount of force applied when an implant is positioned in the apparatus.

2. The apparatus of claim 1, wherein the spring is a first spring and wherein the tensioner further comprises a second spring configured to have a different amount of stiffness from the first spring in order to generate a rotational force that is applied when an implant is positioned in the apparatus responsive to application of the translational force by the linear actuator.

3. The apparatus of claim 1, wherein the spring is a first spring, wherein the tensioner further comprises a second spring, and wherein the one or more sensors comprises a first load sensor coupled to the first spring and a second load sensor coupled to the second spring.

4. The apparatus of claim 1, wherein, responsive to application of the translational force on the simulated proximal tendon, linear motion of the simulated proximal tendon is transferred to motion in the simulated distal tendon and stretches the spring.

5. The apparatus of claim 1, wherein the one or more sensors comprises a load sensor couple to the spring.

6. The apparatus of claim 1, wherein the one or more sensors comprises a load sensor coupled to an output of the linear actuator or included in the linear actuator.

7. The apparatus of claim 1, wherein the second, top layer of simulated tissue is thinner than the first, base layer of simulated tissue.

8. The apparatus of claim 1, wherein the enclosure comprises a first clamp and a second clamp positioned on opposite sides of the enclosure, and wherein a tautness of the second, top layer of simulated tissue is adjusted by changing a distance between the first clamp and the second clamp using a tightening mechanism.

9. The apparatus of claim 8, wherein the enclosure further comprises a first pair of rails extending from a first side of the enclosure and a second pair of rails extending from a second side of the enclosure, and wherein the first clamp is configured to move along the first pair of rails and the second clamp is configured to move along the second pair of rails responsive to adjustment of the tightening mechanism.

10. The apparatus of claim 1, wherein the one or more sensors comprises a pressure sensor positioned between the first, base layer of simulated tissue and the second, top layer of simulated tissue.

11. The apparatus of claim 1, further comprising a solution bath, wherein the enclosure is at least partially submerged in the solution bath.

12. The apparatus of claim 1, wherein the simulated proximal tendon traverses a path from the linear actuator around a pulley system to the implant.

13. The apparatus of claim 1, wherein the simulated distal tendon traverses a path from the tensioner around a pulley system to the implant.

14. A method of testing an implant, the method comprising:
attaching an implant between a simulated proximal tendon and one or more simulated distal tendons using one or more attachment mechanisms;
inserting the implant in an enclosure including a top layer of simulated tissue and a base layer of simulated tissue, wherein the implant is positioned between the top layer of simulated tissue and the base layer of simulated tissue;
attaching a first end of the simulated proximal tendon to a linear actuator;
attaching a second end of the simulated distal tendons to a tensioner;
operating the linear actuator to apply a translational force to the simulated proximal tendon and, under a first condition in which the one or more simulated distal tendons comprises one distal tendon, to subject the implant to translational forces from the linear actuator and the tensioner, or, under a second condition in which the one or more simulated distal tendons comprises two distal tendons, to subject the implant to translational and rotational forces from the linear actuator and the tensioner; and
measuring an amount of abrasion of a coating of the implant or measuring a strength of the attachment mechanisms.

15. The method of claim 14, further comprising adjusting a targeted pressure applied over the implant by adjusting a tautness of the top layer of simulated tissue.

16. The method of claim 14, wherein, under the second condition, the tensioner comprises a first spring and a second spring, and wherein the method further comprises adjusting a targeted rotational force applied to the implant by adjusting a differential stiffness of the first spring relative to the second spring.

17. The method of claim 14, further comprising immersing the implant in a solution bath.

18. An apparatus for testing an implant in a simulated environment, the apparatus comprising:
a linear actuator;
a tensioner comprising one or more springs;
an enclosure comprising:
a shell including a plurality of rails extending from opposite sides of the shell;
a first clamp and a second clamp respectively positioned over the plurality of rails on the opposite sides of the shell, and
a tightening mechanism, wherein a distance between the first clamp and the second clamp is adjustable along the rails using the tightening mechanism; and
one or more sensors configured to measure an amount of force applied by the apparatus.

19. The apparatus of claim 18, wherein the enclosure further comprises a first, base layer of simulated tissue disposed in the shell and a second, top layer of simulated tissue extending between the first clamp and the second clamp, wherein an implant is positionable between the first, base layer and the second, top layer, and wherein a tautness of the second, top layer of simulated tissue is adjustable by changing the distance between the first clamp and the second clamp using the tightening mechanism.

20. The apparatus of claim 18, further comprising a simulated proximal tendon coupled to the linear actuator, wherein the linear actuator is configured to apply a translational force on the simulated proximal tendon, and simulated distal tendons respectively coupled to the one or more springs, wherein an implant is coupleable between the simulated proximal tendon and the simulated distal tendons.
